(19) United States
(12) Patent Application Publication
(10) Pub. No.: US 2002/0098336 A1
(43) Pub. Date: Jul. 25, 2002

(54) Pressed ceramic fiber board and method of manufacture

(76) Inventor: Thomas A. Love, Greensboro, GA (US)

Correspondence Address: Tony D. Alexander, TECHNOLOGY LEGAL COUNSEL, LLC., POST OFFICE BOX 1728, EVANS, GA, 30809, US

(21) Appl. No.: 10/026,196

(22) Filed: Dec. 21, 2001

Related U.S. Application Data
(60) Provisional application No. 60/263,452, filed on Jan. 24, 2001.

(51) Int. Cl. D04H 1/00; B32B 27/04; B32B 27/12

(52) U.S. Cl. 428/292.1; 428/297.4; 156/62.2; 156/246

(57) ABSTRACT

A fibrous high temperature pressed rigid board is made using alumina silica fiber, soluble fiber (so-called green fiber or body fluid soluble fiber) or mineral wool or a combination of two or more of the above fiber types. The board is made by adding a water soluble, inorganic, granular/powder binder to the fiber at a point in the process between the fiber collection chamber and the blowing nozzle or spinning apparatus so that the binder is dispersed throughout the fiber as the continuous fleece or blanket is being produced. The fiber can also be accumulated on a wheel until the desired thickness or basis weight is achieved. The fleece is cut into a predetermined size and is then subjected to the application of water spray and placed into a hot press at a temperature sufficient to cause the water to heat and produce steam which rapidly dissolves the binder within the fleece and left in the press until dry or nearly dry. The solubility of the binder is affected by the temperature of the water and steam and to the benefit of the product; it is not equally reversible, which is to say that the binder does not dissolve again if subjected to water after the board has been pressed. The binder chemically reacts with the fiber used in the board. The density and thickness are dependent on basis weight of fiber and pressed thickness.

This patent application claims the benefit of priority under 35 U.S.C. §119 to co-pending U.S. Provisional Application Ser. No. 60/263,452, filed Jan. 24, 2000.

### FIELD OF THE INVENTION

The present invention relates generally to a pressed rigid board and more particularly to a system and a method of providing a high temperature fibrous insulating board in particular.

### BACKGROUND OF THE INVENTION

In the refractory industry, high temperature fibrous insulating boards are typically produced using a slurry-vacuum-mold forming method. The standard practice is to mix by weight percent, 4-10% fiber, 3-8% colloidal silica with water making up the remaining +/−90%. Dissolved or dry cornstarch is then added sufficient to “flock” the slurry. The order of addition can be changed, ending with either starch or colloidal silica. Colloidal alumina can be substituted for silica for the desired property differences. Into this slurry a screened surface mold is placed, connected to a vacuum hose to draw the slurry to the molds screen surface. The fiber builds up on the screen surface and after desired thickness is achieved the shape is taken off the mold. The mold can be of an infinite variety of shapes from flat boards, cylindrical, spherical, or stepped intricate shapes. The fiber can vary widely, but a few are refractory ceramic fiber, mineral wool and “green” fiber (body fluid soluble). The fiber type determines the temperature use limit of the product. Temperatures can range from 800-2800° F.

There are other methods of producing shapes and flat boards, for instance, the use of slurry presses. These typically use a chamber with the same length and width as the desired board to which a measured amount of slurry is added. The next step is for a platen connected to a hydraulic cylinder to be pressed into this chamber with vacuum connected to either top, bottom or both platen and chamber bottom and after the desired thickness is reached, the platen is stopped and the fibrous piece removed. These vacuum-formed pieces must be dried to give it “green” strength for handle-ability. Upon firing these vacuum-formed pieces, the organic binder, starch, is burned off producing off-gassing. The off gassing is a strong odor and can be offensive to individuals around to smell it. Many companies pre-fire their vacuum-formed pieces to prevent off gassing from occurring at the installation site. A product with similar insulating refractory properties is very desirable to industry for certain markets where the odor is a problem for the end user.

For more than a decade companies have been trying to invent a better method to produce a low cost, insulating, high temperature fiberboard without sacrificing the qualities and properties of the vacuum-formed board. On existing production lines for fiber blanket or logs, attempts have been made to add the binder in many liquid forms just after the fiberization step, but have been unsuccessful.

Therefore, conventional methods of forming boards generally require a protracted drying step and generally give off undesirable gasses. Moreover, vacuum-formed boards require top and bottom surface finishing, grinding or sanding to obtain the target nominal thickness. A one inch thick pressed board typically spends 30 minutes in a 350° F. or higher press, before going on to the next step of cutting to length and width. The vacuum-formed boards of the same thickness typically are placed in a batch dryer for 24 hours. Fewer steps require less handling and contribute to lower production costs in this product.

Therefore, there is an existing need for a fibrous board that can be easily trimmed to a nominal length and width and packaged for sale. This process should result in a lower cost product compared to the vacuum-formed boards.

Moreover, there is a need for a process that uses a totally inorganic binder, which results in no offensive off gassing and significantly increases the upper use limit over the vacuum-formed board. The size of the board should also be limited only by the size of the press platens. There should be no top or bottom surface finishing, grinding or sanding required to obtain the target nominal thickness. Additionally, the process should eliminate the need to place the boards in a batch dryer for 24 hours.

### SUMMARY OF EXEMPLARY EMBODIMENTS

The present inventors have discovered a unique way of addressing all of the above limitations and providing additional advantages. In an exemplary embodiment in accordance with the present invention, a high temperature fiber, soluble fiber (so-called green fiber or body fluid soluble fiber) or mineral wool or a combination of two or more of the above fiber types is used to form a fibrous high temperature pressed rigid board that retains the favorable characteristics of the slurry-vacuum-mold method in a more timely, cost-effective and cleaner manner.

In a preferred embodiment, it is an objective of the invention to provide a fiber board formed by the process, either continuously or in batch, comprising the steps providing a fibrous material, the fibrous material including alumina silica fiber, soluble fiber, mineral wool or a combination thereof; adding dry/granular binder and/or filler material; forming a fibrous mat; accumulating layers of built-up fibrous mat, heating and pressing the fibrous mat to achieve a desired thickness thereof and drying the fibrous mat to form a fibrous high temperature pressed board product.

A principal objective of the present invention is to provide a method of varying the density and thickness of a fibrous high temperature pressed board product. In the furtherance of this and other objectives, fibrous mat can be accumulated on a wheel until the desired thickness or basis weight is achieved, which determines the density and thickness of the resulting board.

Another objective of a preferred embodiment of the present invention is to provide a watering step to dissolve binders.

Still another objective of the present inventions is to provide an alternative to the traditional vacuum-formed ceramic fiber product. In the furtherance of this and other objectives, inorganic binders are used that must be fired to 1600-1800° F. Moreover, since the binder is tacky in the dissolved state, it not only adheres to the fiber but it also chemically reacts with the fiber used in the board. The binder also adheres to common metals such as carbon, steel, aluminum and stainless steel.

Further objectives, features and advantages of the invention will be apparent from the following detailed description taken in conjunction with the accompanying drawings.

### BRIEF DESCRIPTION OF THE DRAWINGS

FIG. 1 is a side view of a preferred fiber production process, with a volumetric feeder for binder addition, in accordance with the present invention.

FIG. 2 is a side elevational view of the process step involving the spraying of the top and bottom of the fleece, with water, and subsequently hot pressing the fleece after the fleece is produced.

FIG. 3 is an enlarged perspective view of a portion of the preferred fiber production process of FIG. 1, with a cutaway showing powder binder added as fiber is being produced.

### DETAILED DESCRIPTION OF THE PREFERRED EMBODIMENTS

A fibrous high temperature rigid board is made using refractory ceramic fiber, soluble fiber (so-called green fiber) or mineral wool, or a combination of two or more fiber types. At the fiber blowing nozzle or just after a fiber spinning apparatus, a powder (water-soluble or water activated) inorganic binder(s) is (are) added at 2-20% of the tap rate to the fiber via a volumetric feeder. (Example—potassium silicate, sodium silicate, phosphate combinations—i.e. aluminum phosphate, boron phosphate) Fiber is collected in either continuous mat form or on an accumulating wheel. On the wheel, logs are produced to a nominal desired thickness and density. After the wheel is completed the log is sawn to proper length and slit on a thickness-slitting saw or “peeled” apart at a desired thickness. On a continuous mat or blanket the fiber is produced to a basis weight that can be pressed into the desired thickness and density. Typically, pieces called “green pelts” are pressed for a period of time to a desired thickness in a hot press.

Prior to pressing, water must be added at a rate of about 20% of the pelt weight on each of the top and bottom surfaces. This must be applied very evenly across each surface to achieve consistent quality and uniform binder wetting. The spraying system can consist of a pressure pump for spraying, a sump pump to return the over-spray to the pressure pump tank. After spraying, the pelts are placed into a hot press heated to 350°-700° F. At 350° F. the pressing time for a 1 inch thick by 16 Lbs/Ft³ board is approximately 30-35 minutes. Press times will increase or decrease depending on board thickness and press temperature.

The board can be produced to a thickness from one quarter to three inches and densities from 10 to 35 Lbs./Ft³. For most of the applications it is felt that a nominal 16 Lbs./Ft³ density is appropriate. One property observed is that as the density increases, the strength, or MOR, dramatically increases. Also seen, the MOR increases as the fired temperature increases through the use range.

The sodium silicate version of the board has a use limit of 2100° F. With potassium silicate binder the board has been tested to 2200° F. with less than about 3% linear shrinkage. There are some phosphate combinations as well as some Secar cements that work with the board. The key requirement is that for this process, the binder needs to be either water-soluble or water activated.

The process for the “pressed fiber board” is a unique process. The green pelts for the “pressed fiber board” can be made on an existing or new fiber production process line with a few modifications or additions. The binder is introduced in powder or granular form at or just after the point of fiberization. Because of the amount of air turbulence in that area the binder is well dispersed in the fiber mat in the settling chamber where fiber is collected in a continuous mat. The thickness and basis weight of the mat is controlled so that the desired density can be achieved with the target thickness. The green pelts are cut from the continuous mat and are staged for the next step of wetting, pressing and drying. The fibrous mat can also be accumulated on wheels until the target thickness and basis weight are achieved. The mat or log is then removed from the wheel and slit and cut to length for the watering-pressing-drying step.

The green pelts are then sprayed with water sufficient to dissolve the inorganic binder, quickly placed into a multi-layer hot press and pressed at desired thickness until the boards are dry. The water sprayed onto the green pelts turns to hot water and steam, while in the press, which is required to dissolve the particular type of binder used. After pressing, the boards are trimmed to a nominal length and width and packaged for sale.

This process results in a lower cost product compared to the vacuum-formed boards. The binder is totally inorganic which results in no offensive off gassing. The size of the boards is limited to the size of the press platens. Typical sizes can be as large as 4′×9′ or larger.

With the powder binder identified, the upper use limit is significantly higher than vacuum-formed boards. There is no top or bottom surface finishing, grinding or sanding required to obtain the target nominal thickness. One inch thick board typically spend 30 minutes in a 350 F. or higher press, before going on to the next step of cutting to length and width. Fewer steps require less handling and contribute to lower production costs in this product. The vacuum-formed boards of the same thickness typically are placed in a batch dryer for 24 hours.

For larger sizes this powder binder can be mixed with bulk, chopped fiber, distributed onto sheets of material to support the fiber, where water can be added and then pressed as described above.

Product Description

A fibrous high temperature rigid board is made using alumina silica fiber, soluble fiber or mineral wool fiber or a combination of two or more of the above fiber types. There are no organic binders added to the board, but during fiber production a lubricant is used to cool the blowing nozzle and to help attenuate the fiber. The fiber may retain trace amounts of the lubricant, which may have an organic component, such as animal fat. This lubricant is “cooked off” during the pressing cycle, which can reach temperatures greater than 500° F. so that no off-gassing occurs during the initial firing of the product in its end use. The binder in the board determines the use limit of the product. With sodium silicate the use limit is around 2100° F. with less than 3% shrinkage. With potassium silicate binder, depending on the allowable shrinkage, the use limit is over 2300° F.

The board is made in thickness from less than 1/4 inch to more than 3½ inches and in densities that range from 12 pcf to more than 35 pcf. Fillers such as clays or Secar cements can be added to increase hardness and density. Typical applications are areas where rigid, insulating heat containment boards are needed.

Process Description

A fibrous high temperature rigid board is made using alumina silica fiber, soluble fiber or mineral wool fiber or a combination of two or more of the above fiber types. At the blowing nozzle or just after a fiber spinning apparatus a powder/granular, water soluble or water activated binder(s) is (are) added to the fiber at a rate of 2-20% of the production or tap rate via a feeder (example-volumetric feeder). Fillers are also added in the same manner as binder which can give the board additional properties such as hardness and improved machineability. Fiber is collected in either a continuous mat form or on an accumulating wheel. On the wheel, mats or pelts are produced to a nominal thickness and density so that they can be processed as is or cut to thickness and size, and processed into boards. In continuous mat form, the mat is produced with a basis weight so that the finished pressed board conforms to the desired thickness and density.

Typically, pieces called “pelts” are subjected to a water spray equivalent to about 10% to 30% of the weight of the pelt on each top and bottom surface. The wet pieces are then hot pressed for a period of time and at a temperature sufficient to generate steam and dry the piece. At that point, during pressing, the pelt becomes a board. The density and thickness is dependent on the basis weight of the fiber and the thickness that the boards are pressed to. Thickness' can range from less than 1/4 inch to 3½ inches and densities through pressing can be obtained from less than about 12 pcf to greater than about 35 pcf.

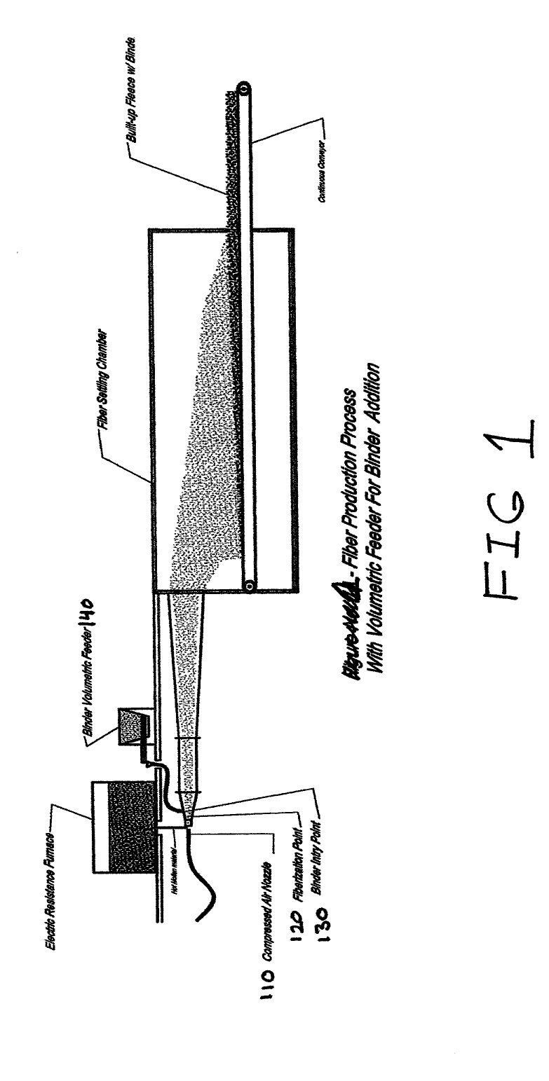

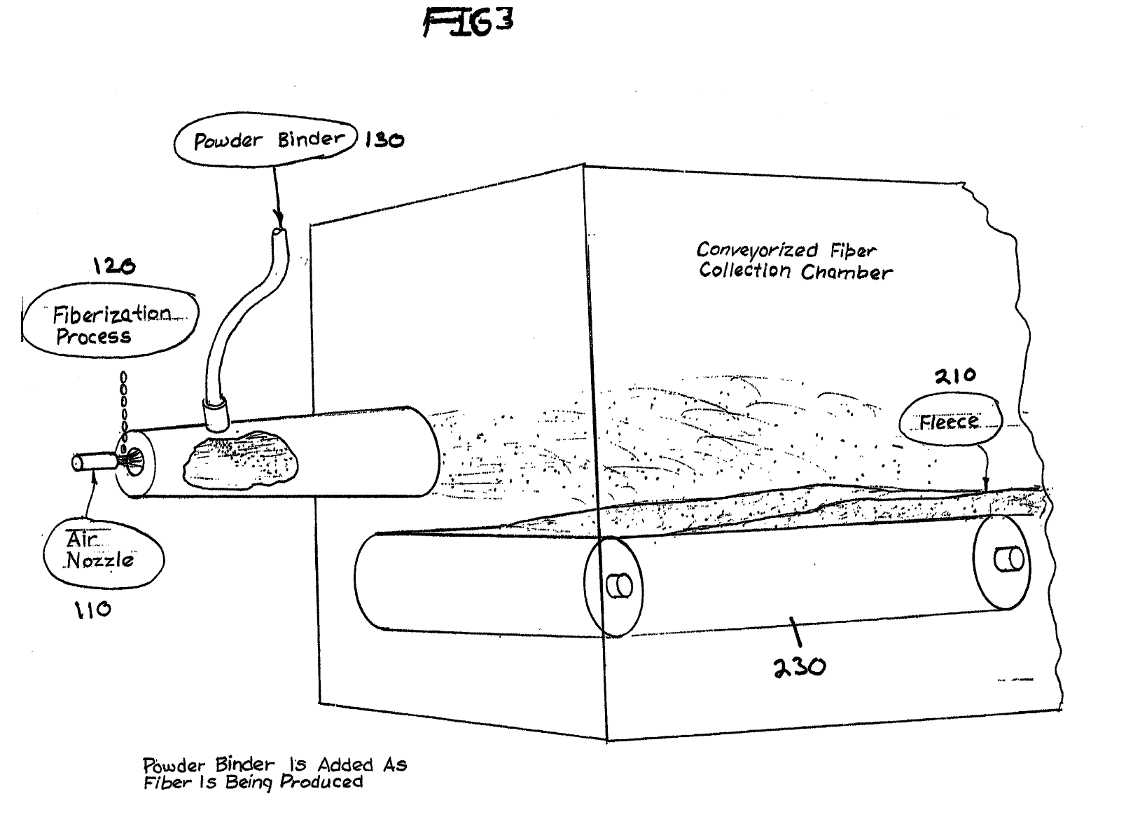

In particular, referring to FIGS. 1 and 3, a fibrous high temperature rigid board is made using alumina silica fiber, soluble fiber or mineral wool fiber or a combination of two or more of the above fiber types. At the blowing nozzle 110 or just after a fiberization point 120 a powder/granular, water soluble or water activated binder(s) is (are) added at the binder entry point 130 to the fiber at a rate of 2-20% of the production or tap rate via a feeder 140. Fillers are also added in the same manner as binder which can give the board additional properties such as hardness and improved machineability. Fiber 150 is collected in either a continuous mat form or on an accumulating wheel. On the wheel, mats or pelts are produced to a nominal thickness and density so that they can be processed as is or cut to thickness and size, and processed into boards. In continuous mat form, the mat is produced with a basis weight so that the finished pressed board conforms to the desired thickness and density.

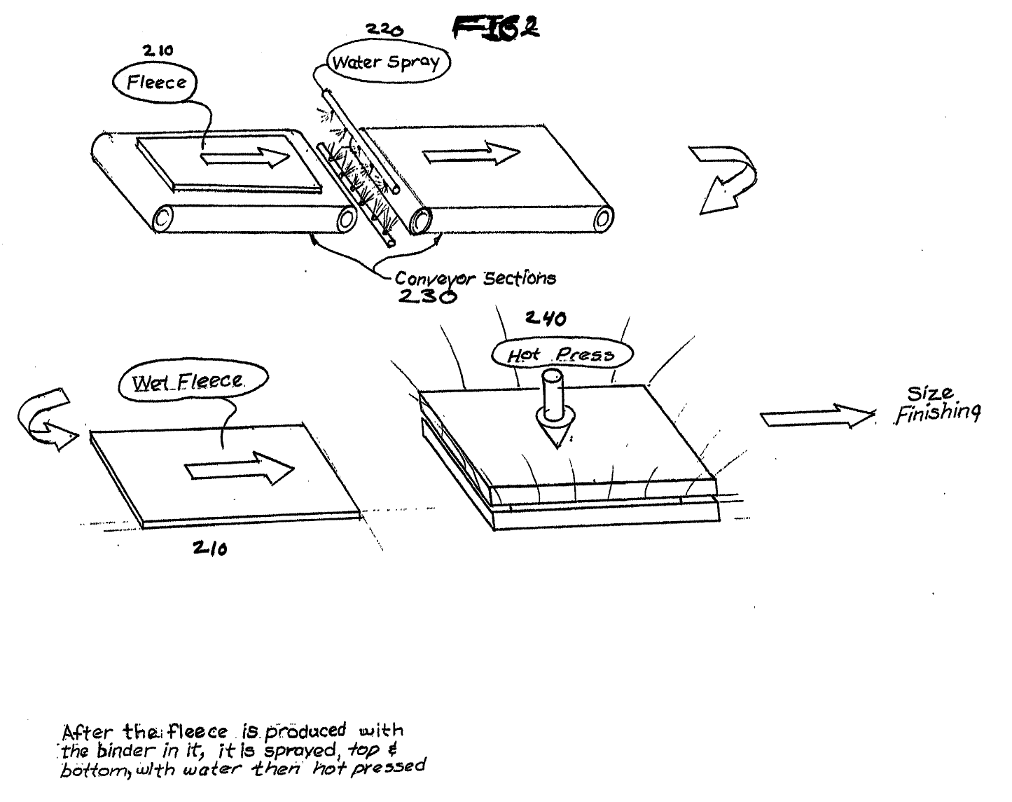

Turning now to FIG. 2, the fleece pelt 210 is subjected to a water spray 220 equivalent to about 10% to 30% of the weight of the pelt on each top and bottom surface as they move along conveyor 230. The wet pelts 210 are then hot pressed 240 for a period of time and at a temperature sufficient to generate steam and dry the piece 210. At that point, during pressing, the pelt 210 becomes a board 250. The density and thickness is dependent on the basis weight of the fiber and the thickness that the boards 250 are pressed to. Thickness' can range from less than 1/4 inch to 3½ inches and densities through pressing can be obtained from less than about 12 pcf to greater than about 35 pcf.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes, which come within the meaning and range of equivalency of the claims, are to be embraced within their scope.

What is claimed is:

1. A high temperature rigid fiber board formed by a process comprising the steps of:
providing a fibrous material, the fibrous material including alumina silica fiber, soluble fiber, mineral wool or a combination thereof;
performing fiberization;
forming a fibrous mat;
accumulating layers of built-up fibrous mat;
heating and pressing the fibrous mat to achieve a desired thickness thereof; and
drying the fibrous mat to form a fibrous high temperature pressed board product.

2. The fiber board formed by a process in accordance with claim 1, the process further comprising the step of: adding a filler material.

3. The fiber board formed by a process in accordance with claim 1, the process further comprising the step of: adding dry/granular binder.

4. The fiber board formed by a process in accordance with claim 2, the process further comprising the step of: adding dry/granular binder.

5. The fiber board formed by the process of claim 3, further comprising the step of adding the binder just after the fiberization step and before the formation of the fibrous mat.

6. The fiberboard formed by the process of claim 3, further comprising the step of adding the binder at the fiberization step and before the formation of the fibrous mat.

7. The fiberboard formed by the process of claim 3, further comprising the step of adding water to dissolve the binder.

8. The fiberboard formed by the process of claim 7, wherein the water is applied just prior to the hot pressing step.

9. The fiberboard formed by the process of claim 7, wherein the water is added in the form of encapsulated moisture in the same vicinity the binder is added.

10. A fiberous board comprising a body of fibers adhered together.

11. The fibrous board of claim 10, wherein the fiber is selected from the group consisting of alumina silica fiber, soluble fiber, mineral wool or any combination of thereof.

12. The fiberous board of claim 10, comprising a body of refractory ceramic fiber and mineral wool adhered to the refractory ceramic fiber.

13. The fibrous board of claim 11, wherein the ceramic fiber and mineral wool are adhered by at least one binder.

14. The fibrous board of claim 13, wherein the at least one binder is an inorganic binder.

15. The fibrous board of claim 14, wherein the inorganic binder is selected from the group consisting powder or granular potassium silicate, sodium silicate or other silicate materials, or phosphate or phosphate based materials and combinations thereof.

16. The fibrous board of claim 15, further comprising at least one filler material selected from the group consisting of clays, cements, perlite or vermiculite and combinations thereof.

17. The fibrous board of claim 13, further comprising at least one filler material selected from the group consisting of clays, cements, perlite or vermiculite and combinations thereof.

18. The fibrous board of claim 15, wherein the fiber weight percent is about 70-98%, the weight percent of binder is 2-20%, and the weight percent of filler is 0-15%.

19. The fibrous board of claim 18, wherein the board is greater than 50% inorganic.

20. The fibrous board of claim 19, wherein the board is greater than 75% inorganic.

21. The fibrous board of claim 20, wherein the board is greater than 85% inorganic.

22. The fibrous board of claim 21, wherein the board is greater than 99% inorganic.

23. The fibrous board of claim 18, which exhibits no off gassing.

24. The fibrous board of claim 10, wherein the binder is added into the process as, or just after, the fiber is being produced or as the mat or fleece is being developed.

25. The fiberboard formed by the process of claim 8, wherein water spray is added to the top and bottom surfaces at a rate of 10-30% of fiber basis weight on each of the two surfaces.

26. The fiberboard formed by the process of claim 25, wherein the water further comprises wetting agents to improve water penetration into the fiber mat.

27. The fiberboard of claim 25, wherein the density and thickness is determined by being subjected to a hot press at a temperature sufficient to produce steam and for a period of time sufficient to dry or nearly dry the board. Typical temperatures are 350° F.-600° F.

28. A process comprising a fiber board incorporating fiber, binder(s), fillers, and using a process wherein the binders are added at or just after a point of fiberization and before formation of a fibrous mat from which the boards are produced in a continuous manner, whereby accumulating wheels of layers of built up fibrous mat of desired thickness is pressed and dried into high temperature fiber boards.

29. A process comprising a fiber board incorporating fiber, binder(s), fillers, and using a process wherein the binders are added at or just after a point of fiberization and before formation of a fibrous mat from which the boards are produced in a continuous manner, whereby accumulating wheels of layers of continuous mat of desired thickness is pressed and dried into high temperature fiber boards.

30. A process comprising a fiber board, free of fillers, incorporating fiber, binder(s) and using a process wherein the binders are added at or just after a point of fiberization and before formation of a fibrous mat from which the boards are produced in a batch manner, whereby accumulating wheels of layers of built up fibrous mat of desired thickness is pressed and dried into high temperature fiber boards.

31. A process comprising a fiber board incorporating fiber, binder(s), fillers, and using a process wherein the binders are added at or just after a point of fiberization and before formation of a fibrous mat from which the boards are produced in a batch manner, whereby accumulating wheels of layers of continuous mat of desired thickness is pressed and dried into high temperature fiber boards.

32. A pressed ceramic fiber board comprising a ceramic fiber, an inorganic binder and a filler.

33. A pressed ceramic fiber board comprising about 70-98% weight percent of alumina silica fiber, soluble fiber, mineral wool or any combination of thereof, about 2-20% of powder or granular potassium silicate, sodium silicate or other silicate materials, or phosphate or phosphate based materials and combinations thereof, and about 0-15% of clay, cement, perlite, or vermiculite and combinations thereof.
